(19) United States
(12) Patent Application Publication
(10) Pub. No.: US 2004/0104057 A1
(43) Pub. Date: Jun. 3, 2004

(54) Electric golf cart drive mechanism

(76) Inventor: Shih-Yuan Yeh, Banciao City (TW)

Correspondence Address: Shih-Yuan Yeh, P. O. Box No. 6-57, Junghe, Taipei, 235, TW

(21) Appl. No.: 10/642,209

(22) Filed: Aug. 18, 2003

(30) Foreign Application Priority Data
Nov. 4, 2002 (TW) 091217631

(51) Int. Cl. B62D 51/04

(52) U.S. Cl. 180/19.1

(57) ABSTRACT

An electric golf cart drive mechanism is constructed to include two wheels pivoted to two sides of a frame of a golf cart, and a drive axle unit configured on one side of the frame of the golf cart, the drive axle unit includes a motor base, a gear axle and a case cover, the drive axle unit is fixedly locked to the frame of the golf cart, and the gear axle is embedded into one wheel, transmission to the wheel on the gear axle is effectuated through a spiral gear driven by a motor, achieving an auxiliary pulling force on the golf cart that provides economy of effort in transporting golf equipment.

### BACKGROUND OF THE INVENTION

(a) Field of the Invention

The present invention relates to an electric golf cart drive mechanism, and more particularly to a drive axle unit singularly installed on one side of a frame of a golf cart, a wheel is pivoted to the extremity of an extended axle, wherewith an auxiliary pulling force on the golf cart is achieved, and provides economy of effort in transporting golf equipment.

(b) Description of the Prior Art

Golf is a healthy, outdoor recreation, and in order to economize on the effort required to carry a heavy golf club bag, prior inventors have extended designs for a golf cart with specialized usage to transport golf equipment, thereby assisting and providing convenience to personage in transporting golf equipment.

Based on phases of research and development and mode of transmission, described below are different structures of a golf cart separated into common types, along with drawings to accompany explanations of implied shortcomings of prior art structural transmission modes and overall structure thereof.

Referring to FIGS. 1A, 1B, 1C and 2, FIG. 1A shows a structure of a prior art golf cart 10 having a mode of transmission employing two wheels, wheels 13 are respectively fixedly locked to a frame 11, the prior art golf cart 10 required resorting to manual effort to transport golf equipment as no transmission mechanism is configured between the two wheels. Subsequently, an inventor installed a central transmission axle 20 mechanism between two transmission wheels 13, whereby a personage presses a switch to start a motor that drives the wheels 13; therewith providing economy of effort in transporting golf equipment.

FIG. 1B shows a three-wheel mode of transmission, the above-mentioned two-wheel transmission is replaced by a three-wheel transmission mode; a central transmission axle 20 is installed between two rear wheels, and a small front wheel facilitated control of direction by a personage when operating the golf cart.

FIG. 1C shows a golf cart altered to utilize a motor transmission unit 30 respectively singularly installed on each of two rear wheels, structure of this golf cart is similarly designed as the golf cart in FIG. 1B with a three wheel transmission mode to transport golf equipment.

From the aforesaid transmission modes of conventional golf carts we can see that all transmission modes utilized retain the requirement for manual effort to transport the golf cart 10, whereby golf equipment is carried forward.

Referring to FIG. 2 which shows a schematic view of operating a golf cart in practice, because of uneven gradient of a golf links, personage are obliged to sometimes transport the golf cart 10 uphill, and sometimes downhill. The structure of a transmission configuration of a central transmission axle 20 is complicated, and maintenance is difficult, furthermore, the transmission axle 20 must be fitted to the golf cart 10 at the same the golf cart 10 is manufactured and before leaving the factory. Subsequently, an improved design of the golf cart was invented, whereby a single motor transmission unit 30 was respectively singularly installed on each wheel 13, thereby simplifying the troublesome aspect of the central transmission axle 20.

Nevertheless, in the aforementioned designs for two wheel or three wheel transmission modes for transporting the golf cart 10, a frame 11 of the golf cart 10 bears the weight of a golf club bag 50, thus, no matter whether transporting the golf cart 10 uphill or downhill, if no brake mechanism is installed between the wheels 13, because the golf cart 10 must bear the weight of the golf club bag 50, maintaining a holding position on the golf cart 10 is difficult, and results in the burdensome aspect of the golf cart 10 coasting. With reference to the arrow direction indicated in FIG. 2, upon the golf cart 10 coasting downhill with the added weight of the golf club bag 50, serious damage results to gears within the transmission axle, whereby the gears can split.

Although the aforementioned structures have been in use for a long period of time, despite their shortcomings, it can be seen applicatory usage of such structures do not meet practical needs of a present consumer, and there is room for a more advanced and improved design.

### SUMMARY OF THE INVENTION

In light of the aforesaid problems being existent, the inventor of the present invention committed research to collate the above-mentioned shortcomings of conventional transmission structures and conceive a transmission mechanism configured for usage on a conventional golf cart, and to enhance convenience and practicality of conventional transmission structures. The present invention is constructed to include a single transmission mode utilizing two wheels attached to a frame of a golf cart, and a singular transmission mechanism singularly configured on one wheel. A personage touches a switch to actuate a drive motor and therefrom transmission to a wheel is initiated, thereby assisting in economizing on effort required to transport golf equipment, moreover, eliminating the requirement for fitting of a brake mechanism. No matter what inclination a golf links a golf cart is positioned on, weight of the frame of the golf cart and golf equipment operates in coordination to achieve effectiveness of maintaining a holding position of the golf cart.

To accomplish the abovementioned objectives, an electric golf cart drive mechanism according to the present invention is constructed to include two wheels pivoted to two sides of a frame of a golf cart, and a drive axle unit configured on one side of the frame of the golf cart. The drive axle unit includes a motor base, a gear axle and a case cover, the drive axle unit is fixedly locked to the frame of the golf cart, and a gear axle is embedded into one wheel, transmission to the wheel on the gear axle is effectuated through a spiral gear driven by a motor, achieving an auxiliary pulling force on the golf cart that provides economy of effort in transporting golf equipment.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1A shows a cross sectional view of a conventional transmission axle structure.

FIG. 1B shows a cross sectional view of another conventional transmission axle structure.

FIG. 1C shows a cross sectional view of a further conventional transmission axle structure.

FIG. 2 shows a schematic view of a conventional golf cart structure operating uphill and downhill.

FIG. 3 shows an exploded elevational view according to the present invention.

FIG. 4 shows a partial enlarged exploded elevational view according to the present invention.

FIG. 5 shows a schematic view of the present invention operating uphill and downhill.

FIG. 6 shows an elevational view according to the present invention.

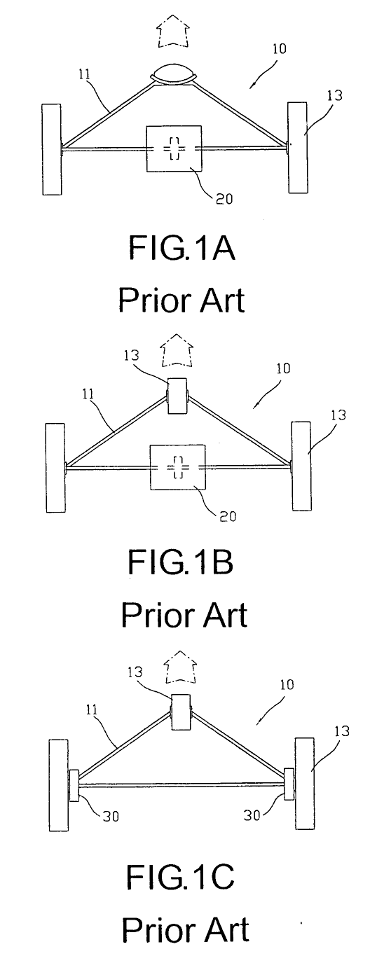

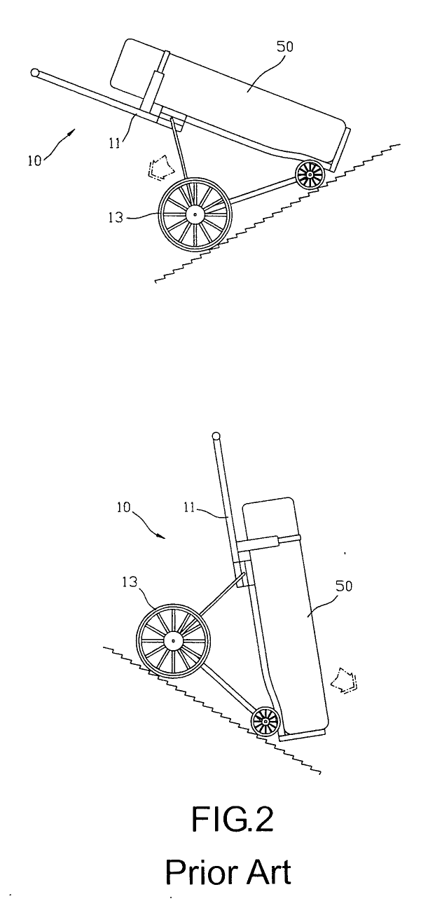

### DETAILED DESCRIPTION OF THE PREFERRED EMBODIMENTS

The main characteristics of the present invention are outlined hereinafter and accompanied by drawings of a feasible and workable model to increase understanding of the present invention:

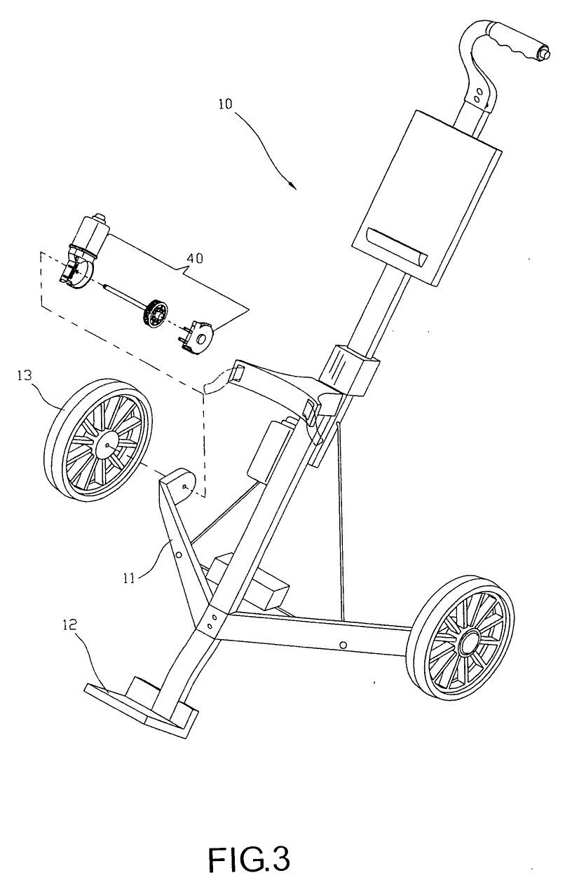

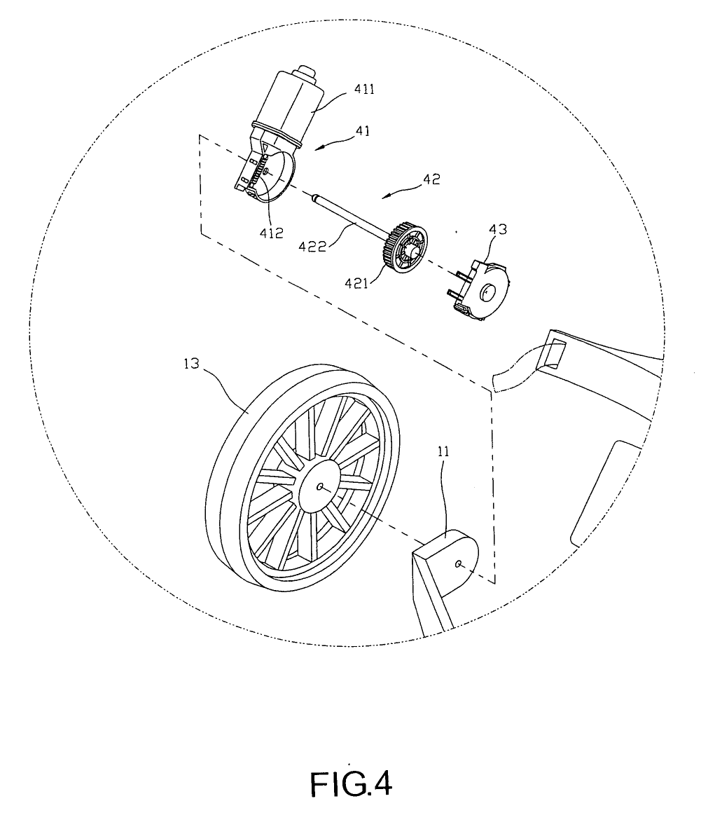

Referring to FIGS. 3 and 4, an electric golf cart drive mechanism of the present invention is constructed to include a drive axle unit 40 installed to operate in coordination with a frame 11 of a golf cart 10, the drive axle unit 40 comprises a motor base 41, a gear axle 42, and a case cover 43, the motor base 41 is cast as an unit to be fixedly locked to the frame 11, a transmission motor 411 and a spiral gear 412 are configured to a casing, a gear axle 42 is installed in a lower end of the casing of the motor base 41, an axle is embedded into a gear 421 having primary usage to lodge into a side wheel 13 thereof. Gear 421 operates in coordination with a pitch of a spiral gear 412, and lubricating oil is anointed between the gear 421 and spiral gear 412 within the casing of the, motor base 41. An outer cover 453 fixedly caps the casing.

The drive axle unit 40 is installed and fixedly locked with several screws to the wheel 13 of the frame 11 of a conventional golf cart; the golf cart utilizes a pull-style mode of transporting golf equipment. The gear axle 42 is embedded into one wheel 13. Because a pulling force through manual effort transports the golf cart 10, the drive axle unit 40 configured within the wheel 13 is brought into actuation to assist in economizing effort required to transport the golf cart, and differs from the transporting motive force actuated by a three wheel golf cart 10 in that it utilizes a singularly installed wheel transmission mode, thereby accomplishing convenience, speed and simplification of installation of the transmission mechanism, furthermore, enhances collocation of conventional golf carts 10, as well as providing assistance in economizing on effort required to pull a golf cart to transport golf equipment.

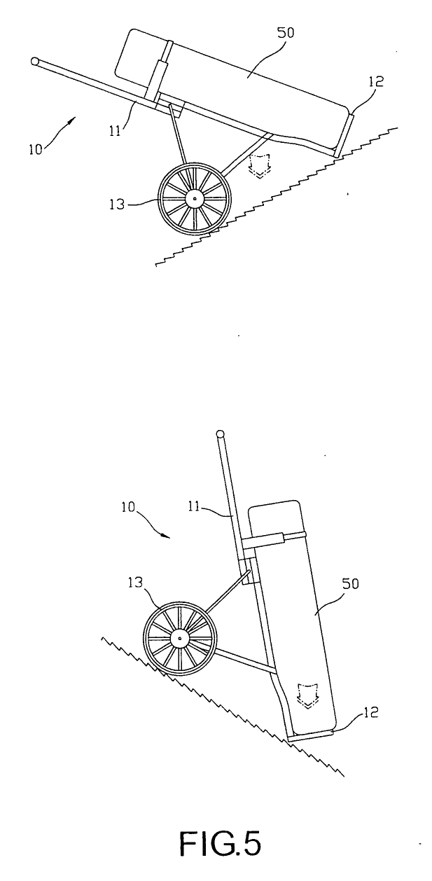

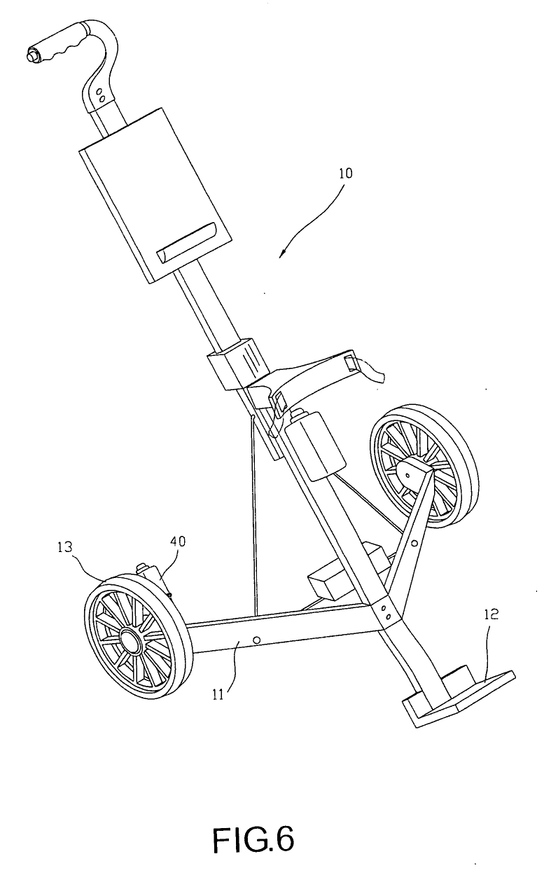

Referring to FIG. 5, which shows an electric golf cart drive mechanism of the present invention being operated when transporting golf equipment uphill and downhill. The present invention provides a transmission mechanism configured for usage on a conventional golf cart 10, enhancing convenience and practicality of structure of the conventional golf cart. The present invention comprises a two-wheel mode of transmission, whereby two wheels are attached to a frame 11 of a golf cart 10, and a single transmission mechanism singularly configured on one wheel 13. A personage touches a switch to actuate a motor 411 that drives a wheel 13, thereby assisting economizing on effort required to transport golf equipment. A golf equipment bag 50 is tied to a support 12 of the frame 11. Because a personage is the principal source of pulling motive force to transport the golf cart 10, a drive axle unit 40 primarily provides an auxiliary drive force. Referring to directions of the arrow in the drawing, when transporting the golf cart uphill, total weight from weight of golf equipment added to weight of the golf cart presses down on a bottom portion of the support 12, thereby the support 12 acts as a prop contact with the ground and achieves a stable holding position for the golf cart 10. When transporting the golf cart 10 downhill, total weight of the golf cart 10 is again allotted equally on a bottom portion of the support 12, exempting need for a brake mechanism to be installed, while achieving effectiveness of maintaining a holding position on the golf cart on all gradients of golf links.

In conclusion, the electric golf cart drive mechanism as disclosed above comprises a drive axle unit singularly configured on one side of a frame, assisting in economizing on effort required to pull a golf cart to transport golf equipment.

When in operation, improved effectiveness of the present invention demonstrates compliance with important patent conditions of advancement and practicality. It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An electric golf cart drive mechanism comprising a drive axle unit fitted to a frame of a golf cart, wherein:
the drive axle is constructed to include a motor base, a gear axle and a case cover; a casing of the motor base is screwed down and fixedly locked to one side of the frame of the golf cart; an extended axle is mounted on one wheel; a transmission motor and spiral gear are installed in the casing; a gear axle is installed in a lower part of the casing of the motor base; an axle is embedded into the gear axle having primary usage to singularly lodge into a side wheel; a gear operates in coordination with a pitch of a spiral gear, and lubricating oil is anointed between the gear and spiral gear within the motor base casing; the case cover fixedly caps the casing.
